(19) United States
(12) Patent Application Publication
(10) Pub. No.: US 2024/0232685 A9
(43) Pub. Date: Jul. 11, 2024

(54) COUNTERFACTUAL BACKGROUND GENERATOR

(71) Applicant: Red Hat, Inc., Raleigh, NC (US)

(72) Inventors: Robert Geada, Newcastle-upon-Tyne (GB); Rui Miguel Cardoso De Freitas Machado Vieira, Newcastle-upon-Tyne (GB)

(21) Appl. No.: 17/972,837

(22) Filed: Oct. 25, 2022

(51) Int. Cl. G06N 20/00; G06N 5/04

(52) U.S. Cl. CPC G06N 20/00; G06N 5/045

(57) ABSTRACT

A plurality of perturbed seed data values may be generated by performing a plurality of perturbation operations on an initial value to be processed by a predictive model. A plurality of counterfactual operations may be performed to generate a plurality of background data values of a background data store based on respective ones of the plurality of perturbed seed data values, a reference value within a domain of a predictive model, and the predictive model. A model analysis engine may be executed to generate a model analysis of the predictive model utilizing the background data store and the initial value.

### TECHNICAL FIELD

Aspects of the present disclosure relate to the analysis of machine learning models, and more particularly, to the analysis of machine learning models utilizing counterfactual background generation.

### BACKGROUND

The field of Explainable Artificial Intelligence (XAI) seeks to investigate the intuition of black-box models, which may include predictive systems whose inner workings are either inaccessible or so complex as to be conventionally uninterpretable. Common examples of such black-box models are neural networks or random forests. In some cases, explanations of these models may be driven by a variety of regulations. For example, the General Data Protection Regulation (GDPR) of the European Union envisions that subjects of automated decisions may ask for an explanation of the decision-making process that led to said decisions. Furthermore, the behavior of these models may be investigated to ensure they are compliant with regulations and business ethics, for example, verifying the models are not basing their decisions on protected attributes such as race or gender if such things are not relevant to the decision.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a schematic block diagram that illustrates an example system, in accordance with some embodiments of the present disclosure.

FIG. 2 is a schematic block diagram of the generation of a background data store utilizing a counterfactual engine, in accordance with some embodiments of the present disclosure.

FIG. 3 is a schematic block diagram of the generation of a background data store utilizing a non-diverse counterfactual engine, in accordance with some embodiments of the present disclosure.

FIG. 4 is a flow diagram of a method for analyzing a predictive model, in accordance with some embodiments of the present disclosure.

FIG. 5 is a component diagram of an example of a device architecture, in accordance with embodiments of the disclosure.

FIG. 6 is a block diagram of an example computing device that may perform one or more of the operations described herein, in accordance with some embodiments of the present disclosure.

### DETAILED DESCRIPTION

As noted herein, it may be useful to be able to provide explanations for decisions made by predictive models, such as those utilized in artificial intelligence (AI) models. Such models typically take some number of inputs and generate one or more outputs. The outputs may be, for example, a decision (e.g., an authorization decision) and/or a classification based on the provided inputs. As an example, a predictive model may provide an estimated value for a residence based on inputs to the predictive model, which may include features of the residence (e.g., number of rooms, size, location, etc.) As another example, a predictive model may attempt to classify an object found within an image based on characteristics of the object (e.g., size, color, shape, etc.), which may be inputs to the predictive model.

Though the predictive model may provide an output, it may be difficult to understand the underlying rationale for the output. For example, some predictive models are based on complicated training operations which assign weights to various ones of the model inputs, or to multiple (e.g., hundred, thousands, etc.) interactions of the model inputs, which may be difficult to explain. In some cases, the predictive model may act as a “black box” in which the outputs are provided, but the internal operations of the predictive model are inaccessible, such as in a case where the predictive model is proprietary. In such cases, it may be difficult to understand how the inputs were processed to arrive at the output. In some cases, a predictive model may be so complex as to be effectively impossible for a human to understand the decision process adopted by the precision model. For example, using an example in which the predictive model determines a value for a house, the predictive model may determine based on the inputs provided, that the house is worth $500,000. However, this may not explain what features of the house caused it to be valued at $500,000 (e.g., it has four bedrooms and is ten years old) or what features could be changed to alter its value (e.g., the addition of another bedroom may increase its value by $75,000).

As a result, it can be difficult to explain the outputs of the predictive model, which can lead to a lack of confidence in the predictive model. For example, if a predictive model is used to determine potential airline passengers that should be denied access to the flight, it may be very important to be able to explain why a particular passenger is not allowed to board. As another example, if a predictive model is used to determine loan approval, it may be important to verify that a denial of a loan application is not made for improper purpose (e.g., based on a protected characteristic of the applicant, such as race, gender, or age).

One technique to provide such explanations is Shapley Additive exPlanations (SHAP). SHAP is a method based on the game theoretically optimal Shapley values that attempts to explain the prediction of an instance x by computing the contribution of each feature to the prediction. SHAP produces explanations of decisions of a predictive model through the use of a background dataset, which may be a set of representative data points of the model's behavior. The produced explanation of a particular decision is a comparison against the data points within the background dataset. For example, SHAP may analyze a predictive model for valuing a house to determine that having four bedrooms increased the value of the house by $50,000, as compared to background houses within the background dataset.

The use of the background dataset for SHAP provides a number of challenges. For example, a background dataset is selected at least once for every model explained. Since explanations produced for a particular model are comparisons against the chosen background dataset, the quality, intuitiveness, relevance, and general applicability of the explanations are therefore a function of the particular choice of background dataset. The framing of each explanation against the background dataset may limit their interpretability to non-technical consumers. For example, referring to the earlier example regarding a predictive model that identifies the value of a house, it may be difficult for a recipient of an explanation to understand the “background house” to which the data points of the background dataset are compared. As a result, the explanation itself may have limited value. Moreover, a body of existing data points may be used for selecting background points of the background dataset. Such a set of data points may only be accessible to the original designer of the predictive model, and in rule-based models (for example, a business rules engine) these data points may not exist.

The present disclosure addresses the above-noted and other deficiencies by utilizing a counterfactual explainer algorithm, which may be implemented by computer instructions and/or circuitry of a counterfactual engine, to generate background data points that align with the particular comparative needs of the domain of the predictive model. For example, a background reference point may be selected that is intuitive and relevant to the predictive model being analyzed, and the counterfactual explainer may be used to generate the background dataset based on the reference point. The ability to select the reference point may provide a number of advantages. The counterfactual background generator may use only a single datapoint to generate a background. Since at least one datapoint may always exist (e.g., the datapoint being explained), counterfactual background generation allows the use of SHAP operations for predictive models and scenarios that would otherwise be difficult and/or impossible with other background selection techniques, such as with business rules engines and/or decision tables.

In addition, because the techniques described herein allow for the choice of the customized reference point, the choice of reference point can provide a very intuitive reference value for SHAP explanations, grounding each explanation as a comparison against said intuitive reference point. For example, techniques described herein may allow for the generation of an explanation that having four bedrooms increased the value of a house by $50,000, as compared to the average house in a city, where the average house in the given city was selected as the background reference point. In addition, other reference points can be selected, such as a zero data point (e.g., a value of zero). For example, if a reference point for house valuation is chosen having zero value, a comparison can even be omitted, allowing for a determination that having four bedrooms increased the value of the house by $150,000.

Embodiments of the present disclosure improve the functionality of predictive models in that they allow for a concise determination of the weights being given to inputs provided to a predictive model to obtain an output, even when the underlying details of the model, as well as the data points used to train the predictive model, are unavailable. Embodiments of the present disclosure provide a technological computing function not previously available in computing models. For example, embodiments of the present disclosure may improve the functioning of a computer by allowing for the functional determination of underlying calculations and/or weighting in “black box” type predictive models without requiring the processing and/or storage that would be utilized to determine those same elements from the training data and/or internal data of the predictive model. Stated another way, embodiments of the present disclosure may be capable of identifying characteristics of a predictive model even when underlying technical information of the predictive model is not available, while providing intuitive and higher quality analysis of the predictive model than currently available.

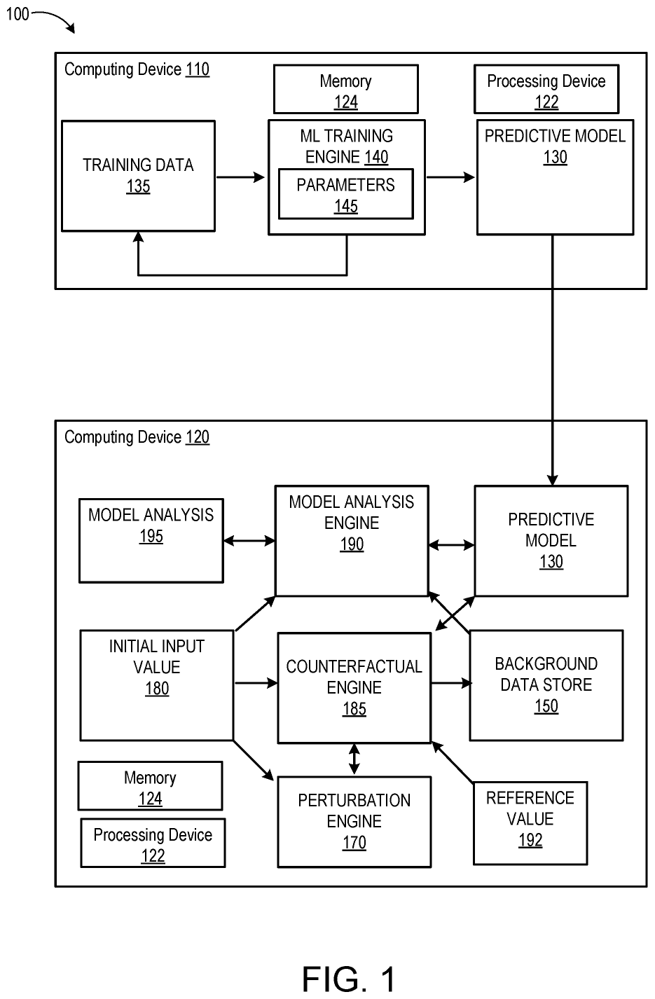

FIG. 1 is a schematic block diagram that illustrates an example system 100, in accordance with some embodiments of the present disclosure. As illustrated in FIG. 1, the system 100 includes a model generation computing device 110 and an analysis computing device 120. The model generation computing device 110 and the analysis computing device 120 may include hardware such as processing device 122 (e.g., processors, central processing units (CPUs)), memory 124 (e.g., random access memory (RAM), storage devices (e.g., hard-disk drive (HDD)), and solid-state drives (SSD), etc.), and other hardware devices (e.g., sound card, video card, etc.).

Processing device 122 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 122 may also include one or more special-purpose processing devices such as an application specific integrated circuit (ASIC), a field programmable gate array (FPGA), a digital signal processor (DSP), network processor, or the like.

Memory 124 may include volatile memory devices (e.g., random access memory (RAM)), non-volatile memory devices (e.g., flash memory) and/or other types of memory devices. In certain implementations, memory 124 may be non-uniform access (NUMA), such that memory access time depends on the memory location relative to processing device 122. In some embodiments, memory 124 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 124 may be configured for long-term storage of data and may retain data between power on/off cycles of the computing devices 110, 120.

The model generation computing device 110 and/or the analysis computing device 120 may comprise any suitable type of computing device or machine that has a programmable processor including, for example, server computers, desktop computers, laptop computers, tablet computers, smartphones, set-top boxes, etc. In some examples, the model generation computing device 110 and/or the analysis computing device 120 may comprise a single machine or may include multiple interconnected machines (e.g., multiple servers configured in a cluster). The model generation computing device 110 and/or the analysis computing device 120 may be implemented by a common entity/organization or may be implemented by different entities/organizations.

As illustrated in FIG. 1, the model generation computing device 110 may generate a predictive model 130. In some embodiments, the predictive model 130 may be a machine learning (ML) model 130. For example, the predictive model 130 may be generated based on training data 135. For example, an ML training engine 140 may analyze the training data 135 to train the predictive model 130, such as by using machine learning techniques. In some embodiments, characteristics of the training data 135 (also referred to as features or feature values) may be extracted to use as input by the ML training engine 140. The predictive model 130 may include, for example, a neural network-based model, a tree-based model, a support vector machine model, a classification-based model, a regression-based model, and the like, though embodiments of the present disclosure are not limited to these configurations.

As part of the training to generate the predictive model 130, the model generation computing device 110 may adjust one or more parameters 145 associated with the predictive model 130. The parameters 145 may be one or more configuration elements of the predictive model 130 that adjust the operation of the predictive model 130. For example, the parameters 145 may be adjusted as part of the training in light of the training data 135. The parameters 145 may be, for example, weights associated with the inputs of the predictive model 130 and/or internal layers of the predictive model 130 that assist in the operation of the predictive model 130. As an example, the parameters 145 may be adjusted by the ML training engine 140 as part of the generation of the predictive model 130 to provide a correlation between inputs to the predictive model 130 and outputs of the predictive model 130. The parameters 145 may be incorporated into the predictive model 130 as part of its operation, but may not be visible from the predictive model 130. In other words, the portions of the predictive model 130 that correlate the inputs of the predictive model 130 to the outputs of the predictive model 130 may not be apparent from the predictive model 130 alone.

The predictive model 130 may be configured to be operated without the training data 135. Thus, the predictive model 130 may be stand-alone. In such an environment, inputs (and/or feature values associated with the inputs) may be provided to the predictive model 130 and outputs, which may include probability predictions, classifications, and the like, may be provided as output of the predictive model 130 based on the inputs. However, because the training data 135 and/or the different parameters 145 utilized to generate the predictive model 130 may not be available, the rationale for an output made by the predictive model 130 may not be immediately apparent. As an example, the predictive model 130 may be configured to classify object in images that are provided to it. In an example, the predictive model 130 may analyze an image to determine with a probability of 90% that an object within the image is a “dog.” However, it may not be obvious what aspects of the object (e.g., size, color, etc.) contributed to that decision, or what weights were associated with the various aspects to make that decision.

Embodiments of the present disclosure may allow for an analysis of the predictive model 130 by the analysis computing device 120. In some embodiments, the analysis computing device 120 may include a model analysis engine 190. The model analysis engine 190 may be configured to generate a model analysis 195 from the predictive model 130 based on an initial input value 180. The model analysis 195 may be or include an explanation for an output provided by the predictive model 130 when provided with the initial input value 180 (and/or feature values associated with the initial input value 180) as input to the predictive model 130. The model analysis 195 may include weights and/or scores attached to feature values of the initial input value 180 that contributed to an output provided by the predictive model 130. For example, if the predictive model 130 is a model for providing values of houses, the initial input value 180 may be a house to be provided as input to the predictive model 130 to determine a value of the house, and the model analysis 195 may be a listing of feature values (e.g., characteristics such as size, number of rooms, location, etc.) of the house (e.g., the initial input value 180) that contributed to a value (e.g., an output) generated by the predictive model 130.

The initial input value 180 may be a data point to be explained by the model analysis 195 generated by the model analysis engine 190. For example, if the predictive model 130 is a machine learning model for predicting a value for a house, the initial input value 180 may be one or more data values associated with a house whose value is to be predicted by the predictive model 130. As another example, if the predictive model 130 is a machine learning model for classifying an object, the initial input value 180 may be one or more data values associated with an object to be classified by the predictive model 130.

In some embodiments, the model analysis engine 190 may generate the model analysis based on the predictive model 130, the initial input value 180, and data values of a background data store 150. In some embodiments, the background data store 150 may include one or more data values of a background data set that are representative data values to be provided as input to the predictive model 130. The model analysis 195 generated by the model analysis engine 190 may include a comparison of the initial input value 180 to the representative data of the background data store 150.

In some embodiments, the model analysis engine 190 may operate according to a Shapley Additive Explanations (SHAP) algorithm. SHAP is described in Lundberg, Scott M., and Su-In Lee, “A unified approach to interpreting model predictions,” Advances in Neural Information Processing Systems (2017). SHAP is a method to explain individual predictions that are based on game theoretically optimal Shapley values. One goal of SHAP is to explain the prediction of initial input value 180 by computing the contribution of each feature value of the initial input value 180 to the prediction made by the predictive model 130. The SHAP algorithm may provide a contribution value (e.g., a weight) for each feature value of the initial input value 180. In such a form, each contribution value marks the contribution that feature value had on the output value of the predictive model 130 (also called the attribution), and a null output value of the model may also be calculated, which provides the model output when every feature value is excluded. In some embodiments, the null output value of the predictive model 130 may be useful, as it may provide an intuitive reference point (e.g., reference value 192) against which other feature values may be compared.

The SHAP explanation method computes Shapley values from coalitional game theory. SHAP takes the initial input value 180 and compares it to the representative data of the background data store 150. For example, to allow for the exclusion of arbitrary features without modification or retraining of the predictive model 130, SHAP operations formulate an approximation of exclusion through the use of the background data store 150, which may include a collection of N representative data points that may ideally represent the “average” inputs to the predictive model 130. This combines the initial input value 180 with the data values of the background data store 150, such that the excluded features in the initial input value 180 are replaced with the values taken by those features in the background data store 150, while included features are left untouched. One of these synthetic data points are generated for each of the data points in the background data store 150, and the expectation of the output of the predictive model 130 over all such synthetic data points may be used to approximate the effect of excluding these features. The rationale is that this emulates replacing a particular feature with the “average” value, thus nullifying any difference it creates.

In a SHAP operation, the model analysis 195 results in a comparison of the initial input value 180 to the background data store 150, with the understanding that the background data store 150 may be considered as containing average values for the predictive model 130. The generation of the background data store 150, however, may be difficult. In some embodiments, the background data store 150 may be populated by training data (e.g., training data 135) used to generate the predictive model 130. However, as illustrated in FIG. 1, the training data 135 may be unavailable to the analysis computing device 120. For example, the training data 135 may be proprietary or otherwise inaccessible to the analysis computing device 120. In such a scenario, the generation of the background data store 150 may be problematic. Random numbers could be used, but this may violate the assumption that the values of the background data store 150 may be average values as input into the predictive model 130.

In some embodiments, to generate the background data store 150, a counterfactual engine 185 may be used. The counterfactual engine 185 may include a set of computer instructions and/or an electronic circuit configured to execute operations implementing a counterfactual explanation algorithm. A counterfactual explanation reveals what should have been different in an instance to observe a diverse outcome. Counterfactual explanations suggest what should be different in the input instance to change the outcome of the predictive model 130. For instance, a bank customer asks for a loan that is rejected as a result of an output (prediction) of a predictive model 130. The counterfactual explanation consists of what should have been different for the customer in order to generate a loan acceptance decision by the predictive model 130. An example of counterfactual is: “if the income would have been $1000 higher than the current one, and if the customer had fully paid current debts with other banks, then the loan would have been accepted” by the predictive model 130. In some embodiments, a counterfactual explanation may be defined as a function fₖ that takes as input a classifier b, a set X of known instances, and a given instance of interest x, and with its application C=fₖ(x,b,X) returns a set C={x′₁, . . . , x′ₕ} of h≤k of valid counterfactual examples where k is the number of counterfactuals required. In some embodiments, the set X of known instances may be similar to the data values of the background data store 150, the instance of interest x may be similar to the initial input value 180, and the classifier b may be similar to the predictive model 130.

In some embodiments, the counterfactual explanation may be configured to return a plurality of valid counterfactuals (e.g., k>1). Such a counterfactual explainer may be referred to herein as a diverse counterfactual explainer. In some embodiments, the counterfactual may be configured to return a single counterfactual (e.g., k=1). Such a counterfactual explainer may be referred to herein as a non-diverse counterfactual explainer. A non-diverse counterfactual explainer may be such that a given instance of interest x and a set X of known instances will deterministically generate a same single counterfactual.

In some embodiments, the counterfactual engine 185 may include one or more counterfactual explanation algorithms. Non-limiting examples of counterfactual explanation algorithms that may be used for the counterfactual engine 185 include Optimal Action Extraction (OAE), Wachter's algorithm (proposed by Wachter S, Mittelstadt B D, Russell C (2017) Counterfactual explanations without opening the black box: automated decisions and the GDPR. Harv J L Tech 31:84), contrastive explanation method (CEM), Explanation by Minimal Adversarial Perturbation (EMAP), Model Agnostic Contrastive Explanations Method (MACEM), Flexible Optimizable Counterfactual Explanations for Tree Ensembles (FOCUS), Example-Based CounterFactual explainer (EBCF), Diverse Coherent Explanations (DCE), Actionable Recourse (ACTREC), Distribution-Aware Counterfactual Explanation (DACE), Model-Agnostic approach to generate Counterfactual Explanations (MACE), Diverse Counterfactual Explanations (DICE), Counterfactual Conditional Heterogeneous Autoencoder (C-CHAVE), Actionable REcourse Summaries approach (AIRES), elf aware disCriminant cOUnterfactual explanaTion (SCOUT), Counterfactual Local Explanations via Regression (CLEAR), Search for Explanations for Document Classification (SEDC), Growing Spheres Generation (GSG), CFSHAP, Case-Based Counterfactual. Explainer (CBCE), Tree-Based. Counterfactual Explainer (TBCE), and/or TrustyAI. These examples of counterfactual explainers are merely examples, and other applicable counterfactual explainers will be understood by those of ordinary skill in the art, and are contemplated within the embodiments of the present disclosure.

Referring to FIG. 1, the counterfactual engine 185 may operate (e.g., execute computer instructions and/or function as an electrical circuit) to generate background data values for the background data store 150 based on the initial input value 180 (e.g., the data point to be explained), a reference value 192, and the predictive model 130. In some embodiments, the counterfactual engine 185 may generate a plurality of background data values within the background data store 150 to be used for the model analysis engine 190. The counterfactual engine 185 may generate the plurality of background data values based on the reference value 192.

The reference value 192 may provide a useful reference point to compare other outputs against, that is, one with some intuitive meaning within the context of the predictive model 130. For example, the reference value 192 for a regression-based predictive model 130 may be 0 (e.g., a house whose value is 0), which may be the null output value for the predictive model 130, or the reference value 192 may be the minimum/maximum output from the training data (e.g., a house having a maximum value of those examined). As another example, a reference value 192 for a classifier-type predictive model 130 might be one where each class probability is equally balanced (e.g., Y=1/(number of classes)). As another example, a reference value 192 for a logistic predictive model 130 might be one where the output probability is 50% and/or approximately 50%. As used herein, “approximately” with respect to a nominal value means that the actual value is within 10% of the nominal value.

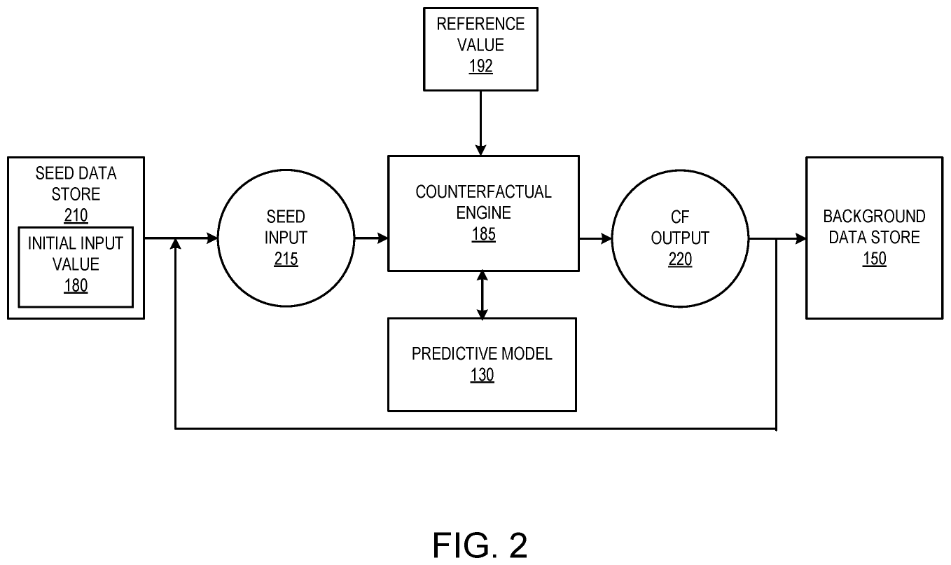

Utilizing the reference value 192 and the initial input value 180, the counterfactual engine 185 may generate background data values of the background data store 150. FIG. 2 is a schematic block diagram of the generation of a background data store 150 utilizing a counterfactual engine 185, in accordance with some embodiments of the present disclosure. A description of elements of FIG. 2 that have been previously described will be omitted for brevity. The operations illustrated in FIG. 2 may be performed, for example, by instructions codes and/or circuitry of analysis computing device 120 of FIG. 1.

Referring to FIG. 2, a seed data store 210 may be provided. In some embodiments, the seed data store 210 may include elements of the training data 135 (see FIG. 1) utilized to generate the predictive model 130, but the embodiments of the present disclosure are not limited to this configuration. In some embodiments, some or all of the training data 135 may not be available. In some embodiments, the seed data store 210 may include the initial input value 180 previously described. The initial input value 180 may include a data point whose processing by the predictive model 130 is to be explained by the model analysis engine 190 (see FIG. 1).

The predictive model 130 may be provided to counterfactual engine 185 and the reference value 192 may be specified. The predictive model 130 may provide a predictive model f( ). As previously described, the reference value 192 may be selected as one or more values within the domain of the predictive model 130 that have some intuitive value. For example, the reference value 192 may be one or more useful comparison points Y within the model domain, such as Y=0, which may represent the null output value of the predictive model 130. The null output of the predictive model 130 may be a value output by the predictive model 130 when every feature value of the input is excluded (e.g., provides no contribution to the output).

In addition, one or more seed data values of a seed data store 210 may be selected. The seed data values may be represented, for example as a set of data points. In some embodiments, the seed data store 210 may include the initial input value 180 (e.g., the input value which is to be explained by the model analysis engine 190).

A single seed input 215 (e.g., the initial input value 180) may be selected from the seed data store 210 and provided to the counterfactual engine 185 along with the reference value 192. The counterfactual engine 185 may generate a counterfactual output (CF output) 220 such that the predictive model of the predictive model 130 f(CF output)=y for some y within the comparison points Y (e.g., reference value 192).

The CF output 220 may be placed within the background data store 150 and the process of selecting a seed input 215 and generating a CF output 220 may be repeated until a sufficient number (e.g., one hundred or more) of background data values are present in the background data store 150.

The embodiment illustrated in FIG. 2 may be useful in embodiments in which the counterfactual engine 185 implements a diverse counterfactual operation, in which a plurality of CF output values 220 may be generated from one or more seed inputs 215. In such an embodiment, a single input data point (e.g., the initial input value 180) may be utilized by the counterfactual operation to generate a plurality of background data values for the background data store 150.

In some embodiments, the counterfactual engine 185 may implement a non-diverse counterfactual operation. A non-diverse counterfactual operation may be such that a given initial input value 180 and the reference value 192 will deterministically generate a same single CF output 220.

For example, the counterfactual operation may be based on stochastic sampling and heuristic search methods, such as by using a Constraint Problem Solver (CPS), which given a specific input and a same random seed, will deterministically generate a same value (e.g., a same CF output 220). In general terms, CPS are a family of algorithms that provide solutions by exploring a formally defined problem space (using constraints) to maximize a calculated score. An example of a CPS is OptaPlanner. The CPS algorithm may allow for boundaries for the feature space in order to perform a search. These boundaries determine a region of interest for the counterfactual domain and do not prevent the application in the situation where training data is not available. The boundaries can be chosen using domain-specific knowledge, model meta-data or even from training data, if available. For numerical, continuous, or discrete attributes, an upper bound and a lower bound may be selected, whereas for categorical attributes, a set with all values to be evaluated during the search may be provided.

The counterfactual search may be performed during a phase of the CPS algorithm consisting typically of a construction heuristic and a local search. The construction heuristic may be responsible for instantiating counterfactual candidates using, for instance, a First Fit heuristic where counterfactual candidates are created, scored and the highest scoring selected. In the local search, which takes place after the construction heuristic, different methods can be applied such as Hill Climbing and/or Tabu search. Tabu search, for instance, selects the best scoring proposals and evaluates points in its vicinity until finding a higher scoring proposal, while maintaining a list of recent moves that should be avoided. The new candidates are then taken as the basis for the next round of moves, and the process is repeated until a termination criterion is met. One of the advantages of using a CPS as the counterfactual search engine is that by defining the counterfactual search as a general constraints problem, different meta-heuristics can be swapped without having to reformulate the problem.

Because non-diverse counterfactual operations may deterministically generate a same CF output 220 for a same seed input 215, the use of non-diverse counterfactual operations may limit the diversity of the generated background data store 150, which may therefore limit the ability of the background data store 150 to represent the diversity of behaviors of the predictive model 130. To address this, the initial input value 180 may be perturbed before generating the CF output 220 by the counterfactual engine 185.

Referring back to FIG. 1, the analysis computing device 120 may further include a perturbation engine 170. The perturbation engine 170 may perform a perturbation operation on the initial input value 180 and provide the perturbation of the initial input value 180 to the counterfactual engine 185. By performing the perturbation of the initial input value 180, a diverse number of background data points may be provided to the background data store 150 even if a non-diverse counterfactual engine 185 is utilized.

The perturbation engine 170 may alter one or more features of the initial input value 180. For example, if the initial input value 180 is a house to be valued, where the house was built in 1963, the value of the year may be changed to 1960 before being provided to the counterfactual engine 185. In some embodiments, more than one feature value of the initial input value 180 may be changed. The perturbation engine 170 may vary a feature value of the initial input value 180 within a particular limit so as to keep the change relatively small. For example, the operation of the perturbation engine 170 may be limited to be within 5% of the range of the feature value. In some embodiments, the operation of the perturbation engine 170 may be limited to be within 10% of the range of the feature value. In some embodiments, the operation of the perturbation engine 170 may be accomplished by replacing and/or augmenting the feature value of the initial input value 180 utilizing random noise or other entropy-based operation.

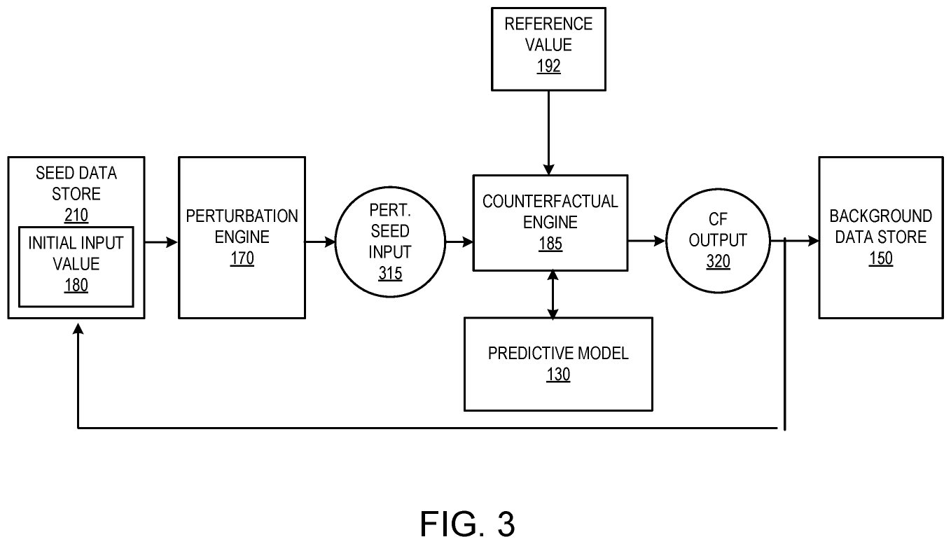

FIG. 3 is a schematic block diagram of the generation of a background data store 150 utilizing a non-diverse counterfactual engine 185, in accordance with some embodiments of the present disclosure. A description of elements of FIG. 3 that have been previously described will be omitted for brevity. The operations illustrated in FIG. 3 may be performed, for example, by instructions codes and/or circuitry of analysis computing device 120 of FIG. 1.

Referring to FIG. 3, the predictive model 130 may be provided to the counterfactual engine 185 and the reference value 192 may be specified. The predictive model 130 may provide a predictive model f( ). As previously described, the reference value 192 may be selected as one or more values within the domain of the predictive model 130 that have some intuitive value. For example, the reference value 192 may be one or more useful comparison points Y within the model domain, such as Y=0, which may be the null output value of the predictive model 130.

The initial input value 180 and/or the seed points of the seed data store 210 may be provided to the perturbation engine 170 to generate a perturbed seed input value 315. The perturbation engine 170 may alter one or more feature values of the initial input value 180 to generate the perturbed seed input value 315. In some embodiments, the alteration of the one or more feature values may be limited to within a certain percentage (e.g., less than 5% or less than 10%) of the range of the feature value of the initial input value 180.

The perturbed seed input value 315 generated by the perturbation engine 170 may be provided to the counterfactual engine 185 along with the reference value 192. The counterfactual engine 185 may generate a counterfactual (CF) output 320 such that the predictive model of the predictive model 130 f(CF output)=y for some y within the reference value 192.

The CF output 320 may be placed within the background data store 150 and the process of perturbing the initial input value 180 by the perturbation engine 170 and providing the perturbed initial input value 180 to the counterfactual engine 185 may be repeated until a sufficient number of background data values are present in the background data store 150. In some embodiments, subsequent operations of the perturbation engine 170 may alter different feature values and/or characteristics of the initial input value 180 so as to generate diversity within the background data store 150.

The embodiment illustrated in FIG. 3 may be useful in embodiments in which the counterfactual engine 185 implements a non-diverse counterfactual operation, where a single CF output value 320 may be generated from the perturbed seed input value 315. In such an embodiment, a single input data point (e.g., the initial input value 180) may be perturbed multiple times and utilized by the counterfactual engine 185 to generate a plurality of background data values for the background data store 150.

Referring back to FIG. 1, once the background data store 150 has been generated (as described herein with respect to FIGS. 2 and 3), the background data store 150 may be utilized along with the initial input value 180 by the model analysis engine 190 to generate the model analysis 195 on the predictive model 130. By utilizing the counterfactual engine 185, the background data store 150 may be generated even in the absence of the training data 135. Moreover, because embodiments of the present disclosure allow for the background data store 150 to be generated with respect to a selected reference value 192, the model analysis 195 may be intuitively tailored to be easier to understand by humans. For example, by selecting a reference value 192 that is associated with the null output value of the predictive model 130, or some other intuitive level of the predictive model 130, the comparison provided by the model analysis 195 may be easier to comprehend. For example, if the null output value of the predictive model 130 is utilized, the comparison provided by the model analysis 195 may be relative to the null output value (e.g., 0) such that the contribution of all the feature values of the initial input value 180 to the output of the predictive model 130 are additive. Similarly, a known output value of the predictive model 130 may be selected as the reference value 192 (e.g., a house worth one million dollars) so that the comparison point may be intuitive to a user. This may be much easier to understand than a comparison to a random non-zero value, or other “average” value that may have little point of reference someone utilizing the model analysis 195. In this way, embodiments of the present disclosure provide a method of analyzing output of a predictive model 130 that is both intuitive and capable of being performed without having access to the internals of the predictive model 130 and/or the training data 135 of the predictive model 130.

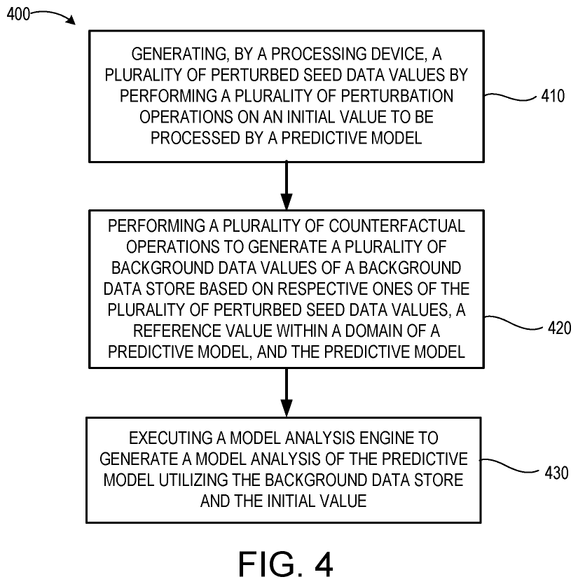

FIG. 4 is a flow diagram of a method 400 for analyzing a predictive model, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 120 illustrated in FIG. 1).

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Referring simultaneously to FIGS. 1 to 3 as well, the method 400 begins at block 410, which includes generating, by a processing device, a plurality of perturbed seed data values by performing a plurality of perturbation operations on an initial value to be processed by a predictive model. In some embodiments, the plurality of perturbed seed data values may be similar to the perturbed seed input values 315 described herein with respect to FIGS. 1 and 3. In some embodiments, the plurality of perturbation operations may be operations similar to those performed by the perturbation engine 170 described herein with respect to FIGS. 1 and 3. In some embodiments, the initial value and the predictive model may be similar to initial input value 180 and predictive model 130, respectively, described herein with respect to FIGS. 1 to 3.

In some embodiments, generating the plurality of perturbed seed data values by performing the plurality of perturbation operations on the initial value comprises performing a first perturbation operation to alter a feature value of the initial value by less than 10% of a range of the feature value.

At block 420, the method may include performing a plurality of counterfactual operations to generate a plurality of background data values of a background data store based on respective ones of the plurality of perturbed seed data values, a reference value within a domain of a predictive model, and the predictive model. In some embodiments, the plurality of counterfactual operations may be operations similar to those performed by the counterfactual engine 185 described herein with respect to FIGS. 1 to 3. In some embodiments, the reference value may be similar to reference value 192 described herein with respect to FIGS. 1 to 3. In some embodiments, the plurality of background data values of a background data store may be similar to the data values of the background data store 150 described herein with respect to FIGS. 1 to 3.

In some embodiments, the plurality of counterfactual operations include a non-diverse counterfactual operation. In some embodiments, the reference value comprises a null output value of the predictive model. In some embodiments, the reference value comprises at least one of a minimum value of an output range of the predictive model, a maximum value of the output range of the predictive model, a first output value for which a class probability for each class predicted by the predictive model is equal, or a second output value for which a predicted probability by the predictive model is fifty percent and/or approximately fifty percent.

At block 430, the method may include executing a model analysis engine to generate a model analysis of the predictive model utilizing the background data store and the initial value. In some embodiments, the model analysis engine and the model analysis may be similar to the model analysis engine 190 and the model analysis 195, respectively, described herein with respect to FIG. 1. In some embodiments, the model analysis engine may include a SHAP algorithm.

In some embodiments, the method may further include processing the initial value by the predictive model to generate an output value. In some embodiments, the model analysis of the predictive model comprises respective contributions of feature values of the initial value to the output value.

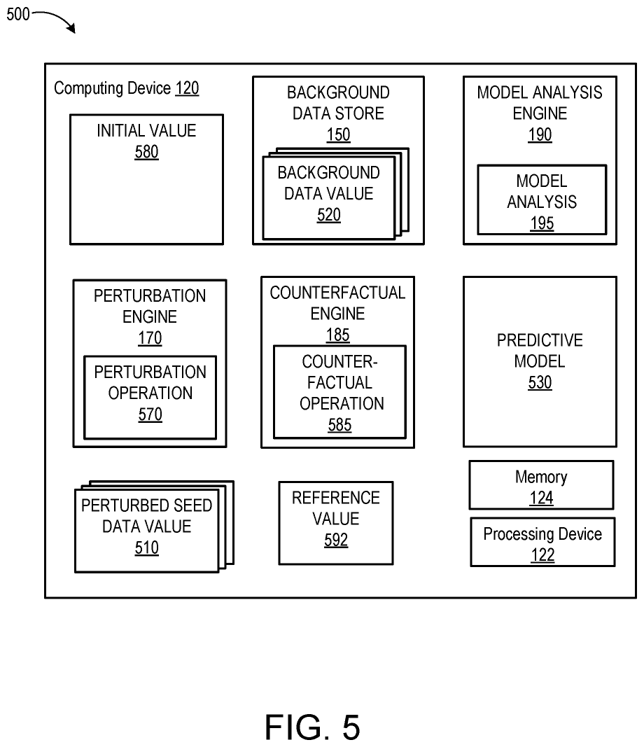

FIG. 5 is a schematic block diagram illustrating an example embodiment of a computer system 500 for analyzing a predictive model 130, in accordance with some embodiments of the present disclosure. A description of elements of FIG. 5 that have previously described has been omitted for brevity.

Referring to FIG. 5, computer system 500 may include computing device 120, including memory 124 and processing device 122, as described herein with respect to FIGS. 1 to 4. The processing device 122 may execute instruction code (e.g., as accessed from memory 124), portions of which are illustrated in FIG. 5.

As illustrated in FIG. 5, the computing device 120 (e.g., analysis computing device 120 as described herein with respect to FIG. 1) may run a model analysis engine 190, a counterfactual engine 185 and a perturbation engine 170. For example, the model analysis engine 190, the counterfactual engine 185 and/or the perturbation engine 170 may be stored as computer instructions in memory 124, and may be executed by processing device 122. The computing device 120 may also include a predictive model 530. The predictive model 530 may be, for example, an ML-based predictive model 530 that is configured to generate an output value based on one or more feature values of an input value. The predictive model 530 may be, for example, a regression-based predictive model 530, a classifier-based predictive model 530, and/or a logistic predictive model 530, to name just a few examples. In some embodiments, the predictive model 530 may be similar to the predictive model 130 described herein with respect to FIGS. 1 to 4.

The computing device 120 may generate (e.g., by processing device 122) a plurality of perturbed seed data values 510 by performing a plurality of perturbation operations 570 on an initial value 580. The initial value 580 may be similar to initial input value 180 described herein with respect to FIGS. 1 to 4. The plurality of perturbation operations 570 may be performed by a perturbation engine 170 similar to that described herein with respect to FIG. 3. In some embodiments, the plurality of perturbed seed data values 510 may be similar to the perturbed seed input values 315 described herein with respect to FIGS. 1 to 4.

In some embodiments, the computing device 120 may perform a plurality of counterfactual operations 585 to generate a plurality of background data values 520 of a background data store 150 based on respective ones of the plurality of perturbed seed data values 510, a reference value 592 within a domain of the predictive model 530, and the predictive model 530. In some embodiments, the plurality of counterfactual operations 585 may be operations similar to those performed by the counterfactual engine 185 described herein with respect to FIGS. 1 to 4. In some embodiments, the reference value 592 may be similar to reference value 192 described herein with respect to FIGS. 1 to 4. In some embodiments, the plurality of background data values 520 of the background data store 150 may be similar to the data values of the background data store 150 described herein with respect to FIGS. 1 to 4.

In some embodiments, the computing device 120 may execute a model analysis engine 190 to generate a model analysis 195 of the predictive model 530 utilizing the background data store 150 and the initial value 580. In some embodiments, the model analysis engine 190 and the model analysis 195 may be similar to the model analysis engine 190 and the model analysis 195, respectively, described herein with respect to FIGS. 1 to 4. In some embodiments, the model analysis engine 190 may include a SHAP algorithm.

The computer system 500 of FIG. 5 provides the ability to generate an intuitive explanation for results obtained from the predictive model 530, even when training data used to generate the predictive model 530 is not available. The computer system 500 also allows the ability to select a reference value 592 against which the model analysis 195 may be compared. The ability to select the reference value 592 allows for the resulting model analysis 195 to be compared against known values, such as a minimum value of an output range of the predictive model 530, a maximum value of the output range of the predictive model 530, an output value for which a class probability for each class predicted by the predictive model 530 is equal, and/or an output value for which a predicted probability by the predictive model 530 is fifty percent and/or approximately fifty percent. The computer system 500 provides technological improvement to conventional devices in that it provides an ability to accurately explain decisions of the predictive model 530 despite not having access to the training data and/or internal parameters of the predictive model 530, and thus the computer system 500 may be capable of performing additional functionality not capable in conventional computer systems.

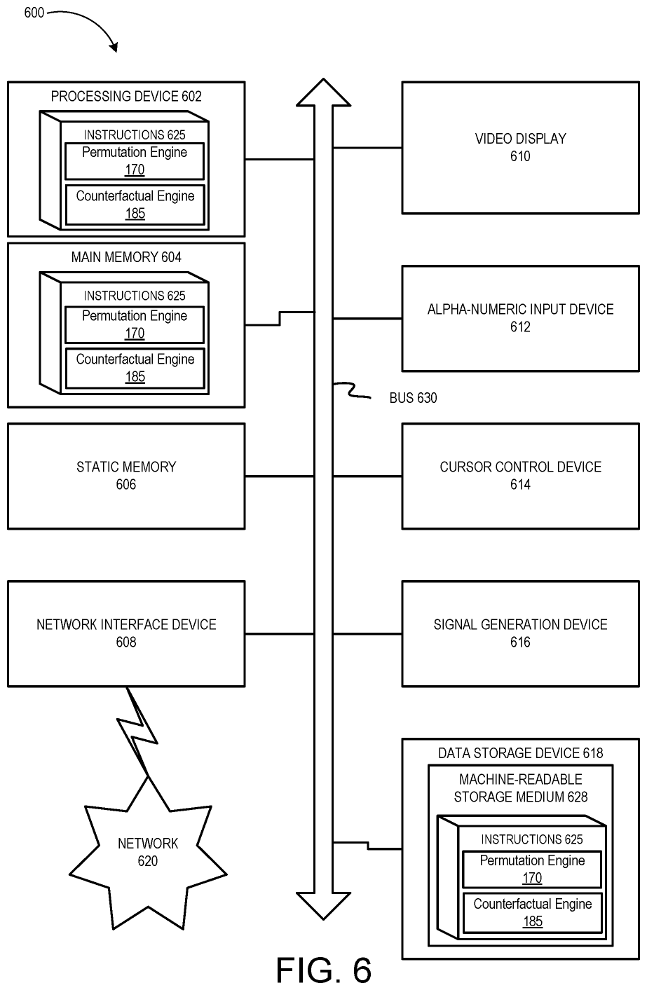

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general-purpose processor, a PLD, etc.) 602, a main memory 604 (e.g., synchronous dynamic random-access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a analyzing a predictive model, e.g., perturbation engine 170, counterfactual engine 185, and/or model analysis engine 190, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “generating,” “performing,” “executing,” “processing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
generating, by a processing device, a plurality of perturbed seed data values by performing a plurality of perturbation operations on an initial value to be processed by a predictive model;
performing a plurality of counterfactual operations to generate a plurality of background data values of a background data store based on respective ones of the plurality of perturbed seed data values, a reference value within a domain of a predictive model, and the predictive model; and
executing a model analysis engine to generate a model analysis of the predictive model utilizing the background data store and the initial value.

2. The method of claim 1, wherein the model analysis engine generates the model analysis of the predictive model further utilizing a Shapley Additive exPlanations (SHAP) operation.

3. The method of claim 1, wherein the plurality of counterfactual operations comprise a non-diverse counterfactual operation.

4. The method of claim 1, wherein generating the plurality of perturbed seed data values by performing the plurality of perturbation operations on the initial value comprises performing a first perturbation operation to alter a feature value of the initial value by less than 10% of a range of the feature value.

5. The method of claim 1, wherein the reference value comprises a null output value of the predictive model.

6. The method of claim 1, further comprising:
processing the initial value by the predictive model to generate an output value,
wherein the model analysis of the predictive model comprises respective contributions of feature values of the initial value to the output value.

7. The method of claim 1, wherein the reference value comprises at least one of a minimum value of an output range of the predictive model, a maximum value of the output range of the predictive model, a first output value for which a class probability for each class predicted by the predictive model is equal, or a second output value for which a predicted probability by the predictive model is approximately fifty percent.

8. A system comprising:
a memory; and
a processing device, operatively coupled to the memory, to:
generate a plurality of perturbed seed data values by performing a plurality of perturbation operations on an initial value to be processed by a predictive model;
perform a plurality of counterfactual operations to generate a plurality of background data values of a background data store based on respective ones of the plurality of perturbed seed data values, a reference value within a domain of a predictive model, and the predictive model; and
execute a model analysis engine to generate a model analysis of the predictive model utilizing the background data store and the initial value.

9. The system of claim 8 wherein the model analysis engine is to generate the model analysis of the predictive model further utilizing a Shapley Additive exPlanations (SHAP) operation.

10. The system of claim 8, wherein the plurality of counterfactual operations comprise a non-diverse counterfactual operation.

11. The system of claim 8, wherein, to generate the plurality of perturbed seed data values by performing the plurality of perturbation operations on the initial value, the processing device is to perform a first perturbation operation to alter a feature value of the initial value by less than 10% of a range of the feature value.

12. The system of claim 8, wherein the reference value comprises a null output value of the predictive model.

13. The system of claim 8, wherein the processing device is further to process the initial value by the predictive model to generate an output value, wherein the model analysis of the predictive model comprises respective contributions of feature values of the initial value to the output value.

14. The system of claim 8, wherein the reference value comprises at least one of a minimum value of an output range of the predictive model, a maximum value of the output range of the predictive model, a first output value for which a class probability for each class predicted by the predictive model is equal, or a second output value for which a predicted probability by the predictive model is approximately fifty percent.

15. A non-transitory computer-readable storage medium including instructions that, when executed by a processing device, cause the processing device to:
generate a plurality of perturbed seed data values by performing a plurality of perturbation operations on an initial value to be processed by a predictive model;
perform a plurality of counterfactual operations to generate a plurality of background data values of a background data store based on respective ones of the plurality of perturbed seed data values, a reference value within a domain of a predictive model, and the predictive model; and
execute a model analysis engine to generate a model analysis of the predictive model utilizing the background data store and the initial value.

16. The non-transitory computer-readable storage medium of claim 15, wherein the model analysis engine is to generate the model analysis of the predictive model further utilizing a Shapley Additive exPlanations (SHAP) operation.

17. The non-transitory computer-readable storage medium of claim 15, wherein the plurality of counterfactual operations comprise a non-diverse counterfactual operation.

18. The non-transitory computer-readable storage medium of claim 15, wherein, to generate the plurality of perturbed seed data values by performing the plurality of perturbation operations on the initial value, the processing device is to perform a first perturbation operation to alter a feature value of the initial value by less than 10% of a range of the feature value.

19. The non-transitory computer-readable storage medium of claim 15, wherein the processing device is further to process the initial value by the predictive model to generate an output value, wherein the model analysis of the predictive model comprises respective contributions of feature values of the initial value to the output value.

20. The non-transitory computer-readable storage medium of claim 15, wherein the reference value comprises at least one of a null output value of the predictive model, a minimum value of an output range of the predictive model, a maximum value of the output range of the predictive model, a first output value for which a class probability for each class predicted by the predictive model is equal, or a second output value for which a predicted probability by the predictive model is approximately fifty percent.
